(19) United States
(12) Patent Application Publication
(10) Pub. No.: US 2014/0056597 A1
(43) Pub. Date: Feb. 27, 2014

(54) System and Method for Broadband Transmissions on a Fiber Optic with Suppression of Second and Third Order Distortions

(71) Applicant: Titan Photonics, Inc., Fremont, CA (US)

(72) Inventors: Chen-Kuo Sun, Escondido, CA (US); Charlie Chen, Santa Clara, CA (US); Eric Liu, Fremont, CA (US)

(73) Assignee: Titan Photonics, Inc., Fremont, CA (US)

(21) Appl. No.: 14/069,228

(22) Filed: Oct. 31, 2013

Related U.S. Application Data
(63) Continuation-in-part of application No. 13/645,292, filed on Oct. 4, 2012.
Application No. 13/645,292 is a continuation-in-part of application No. 13/585,653, filed on Aug. 14, 2012.

(51) Int. Cl. H04B 15/00; H04B 10/58; H04B 10/516

(52) U.S. Cl. CPC H04B 15/00; H04B 10/516; H04B 10/58
USPC 398/198

(57) ABSTRACT

A system and method for transmitting telecommunication signals through a fiber optic, with suppression of second and third order distortions, requires a signal processor for generating a sub-octave broadband signal. An Electro-Absorption Modulator (EAM) is provided to modulate the sub-octave broadband signal into an optical signal λ. And, a DC offset voltage is used to alter optical output power in the optical signal λ. The sub-octave broadband transmission then minimizes second order distortions of the optical signal λ, and the DC offset minimizes third order distortions when the optical signal λ is transmitted on the fiber optic.

This application is a continuation-in-part of application Ser. No. 13/645,292, filed Oct. 4, 2012, which is a continuation-in-part of application Ser. No. 13/585,653, filed Aug. 14, 2012, both of which are currently pending. The contents of application Ser. No. 13/585,653 and application Ser. No. 13/645,292 are hereby incorporated herein by reference.

### FIELD OF THE INVENTION

The present invention pertains generally to signal processing techniques that are useful for transmitting an optical signal over a fiber optic. More particularly, the present invention pertains to systems and methods for minimizing both second and third order distortions in an optical signal as it is transmitted over a fiber optic. The present invention is particularly, but not exclusively, useful for modulating a sub-octave signal to minimize second order distortions during transmission of the signal on a fiber optic, and for using a DC offset biased into an Electro-Absorption Modulator (EAM) for this transmission to minimize third order distortions.

### BACKGROUND OF THE INVENTION

During the transmission of a telecommunication signal over a fiber optic cable (i.e. an optical fiber), the telecommunication signal is susceptible to distortions for many different reasons. Most noticeably, the telecommunication signal is susceptible to nonlinear distortions. Typically, these distortions result from optical and electrical disturbances of the signal that prevent proper signal processing. Perhaps the most notable of these different distortions are the second and third order distortions. In the event, both the second order and third order distortions occur simultaneously and, although they originate for different reasons, they can both be disruptive, either individually or together.

It is known that second order distortions in telecommunication signals can be effectively suppressed by using sub-octave bandwidths. For example, a system for using sub-octave bandwidths to suppress second order distortions is disclosed and claimed in U.S. Pat. No. 8,463,124 which issued to Sun for an invention entitled “Passive Optical Network with Sub-Octave Transmission,” and which is assigned to the same assignee as the present invention.

Insofar as the suppression of third order distortions in a telecommunication signal is concerned, it is known that this can be accomplished by off-setting the optical power of the light beam which is used to carry the signal. It happens that creating sub-octave broadband signals to suppress second order distortions has no effect on third order distortions.

In light of the above, it is an object of the present invention to simultaneously suppress both second order and third order distortions during the transfer of a telecommunication signal over an optical fiber. Another object of the present invention is to effectively suppress third order distortions during the transfer of a telecommunication signal over an optical fiber, by using a DC off-set that accommodates the sub-octave characteristic of the telecommunication signal that suppresses the second order distortions. Still another object of the present invention is to provide a system and method for transmitting telecommunication signals from an upstream end of a fiber optic to the downstream end of the fiber optic, with suppression of both second order and third order distortions, wherein the system and method are easy to use, are respectively simple to implement, and are comparatively cost effective.

### SUMMARY OF THE INVENTION

In accordance with the present invention, a system and method are provided for transmitting telecommunication signals from an upstream end of a fiber optic to the downstream end of the fiber optic. As envisioned for the present invention, the telecommunication signals will originate as a digital data stream before conversion to an analog signal and transmission on the fiber optic. After an optical transmission, the signals will then be converted and transferred to a destination terminal as the same digital data stream. Importantly, during this transmission, both second order and third order distortions are suppressed and/or minimized.

At the upstream end of the fiber optic, the system includes a signal processor having a digital to analog (D/A) converter. A frequency modulator is then provided to modulate the digital data stream (i.e. a telecommunication signal) onto a multi-octave analog signal. Next in line, an up-shift frequency translator is used to up-shift the multi-octave analog signal to a sub-octave broadband signal having a carrier frequency f. In this case, the sub-octave bandwidth for the up-shifted signal will be such that the RF signal f is established between a low frequency (f_{L}) and a high frequency (f_{H}), (i.e. f_{H}<2f_{L}, and f_{L<f<f}_{H}). The purpose here is to suppress and minimize second order distortions during transmission of telecommunication signals on the fiber optic.

In comparison with the bandwidth requirements for a wireless communication system, an up-shifted signal for a fiber optic communication system will typically need a relatively wider bandwidth. For the present invention, however, the up-shifted signal f must still be a sub-octave broadband signal. In detail, the up-shifted signal f will be within a bandwidth between a low frequency f_{L} and a high frequency f_{H}. By definition, f_{H} must be less than twice f_{L}. Moreover, although f_{H} is less than twice f_{L}, it will also need to be approximately equal to twice f_{L}. Thus, the sub-octave bandwidth requirements for the carrier frequency f of the up-shifted signal can be expressed as: f_{L}<f<f_{H}; f_{H}<2f_{L}; and f_{H}≅2f_{L}.

The system of the present invention also includes a light source (e.g. a laser diode) for generating a light beam having a wavelength λ. An Electro-Absorption Modulator (EAM) is provided for receiving the light beam as a first input from the light source, and for receiving the sub-octave broadband signal f as a second input from the signal processor. The EAM then modulates the sub-octave broadband signal f onto the light beam to create an optical signal λ.

Also included in the system of the present invention is a voltage source. Specifically, this voltage source is connected with the EAM to provide a bias voltage (i.e. a DC offset) for altering an optical power of the optical signal λ. The purpose here is to b as the signal power to minimize third order distortions.

For the present invention, the DC off-set and the sub-octave broadband signal f cooperate in combination with each other. Specifically, during the transmission of an optical signal λ over an optical fiber (fiber optic), the DC offset will minimize (suppress) third order distortions of telecommunication signals. At the same time, the frequency characteristics of the sub-octave broadband signal will minimize (suppress) second order distortions of the telecommunication signals.

A receiver at the downstream end of the fiber optic incorporates an optical-electrical (OE) converter to convert the optical signal λ into an RF sub-octave broadband signal. Further, a down-shift frequency translator is included with the receiver for down-shifting the RF sub-octave broadband signal into a multi-octave broadband signal. Next, an analog/digital (A/D) converter is provided for converting the multi-octave broadband signal back into the digital data stream. The digital data stream is then transferred to a destination terminal.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a structural schematic for the components of a fiber optic transmitting system that is used for telecommunication signals in accordance with the present invention;

FIG. 2 is a functional schematic of signal processing activity performed by the system of the present invention;

FIG. 3 is a visual representation of the up-shifting and down-shifting functions performed by the present invention;

FIG. 4 is a graph showing a typical relationship between optical power and voltage bias characteristics of an Electro-Absorption Modulator (EAM) suitable for use with the present invention; and

FIG. 5 is a graph showing the magnitudes of third order distortions during the transmission of a telecommunication signal over a fiber-optic.

### DESCRIPTION OF THE PREFERRED EMBODIMENTS

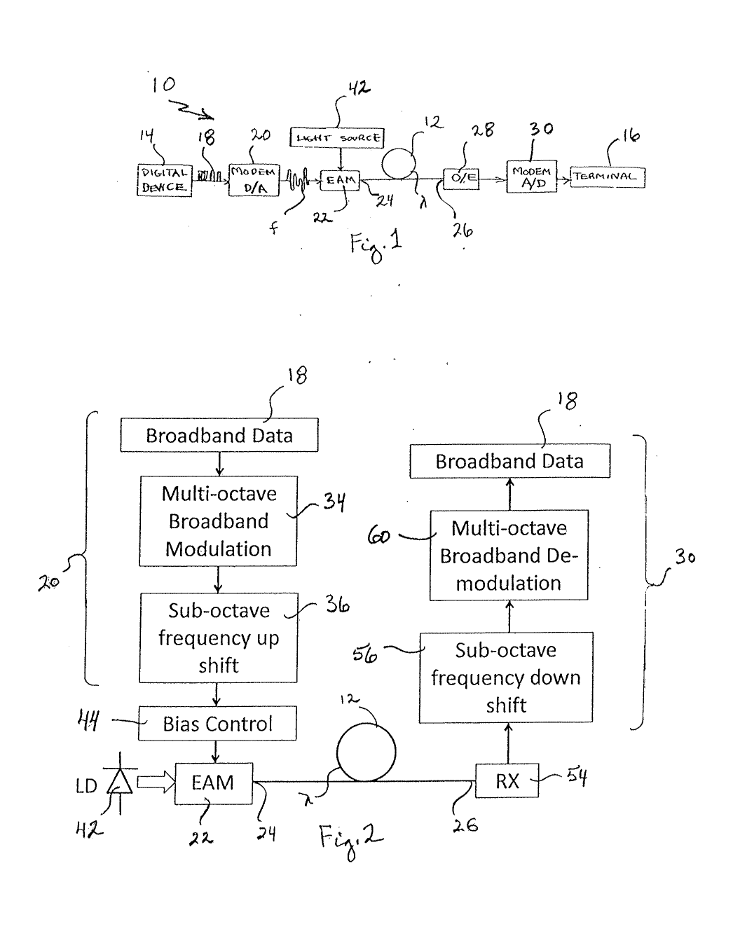

Referring initially to FIG. 1, a system in accordance with the present invention is shown and is generally designated 10. As shown, the system 10 is intended for use in transmitting telecommunication signals over a fiber optic 12 (i.e. optical fiber) from an upstream digital device 14 to a downstream terminal 16. In detail, for the system 10 it is envisioned that the digital device 14 will create a digital signal 18 which is then converted and modulated into a multi-octave analog signal by an upstream signal processor 20. Importantly, this multi-octave analog signal is then up-shifted to a broadband sub-octave signal f. The sub-octave signal f is then further processed by an Electro-Absorption-Modulator (EAM) 22 and converted into an optical signal λ. As shown in FIG. 1, the EAM 22 is connected with an upstream end 24 of the fiber optic 12 for transmission of the optical signal λ over the fiber optic 12 to a downstream end 26 of the fiber optic 12.

At the downstream end 26 of the fiber optic 12, the optical signal λ is converted by an optical/electrical (0/E) converter 28 back into the broadband sub-octave signal f. Further processing of the broadband sub-octave signal f is provided by a downstream signal processor 30. Specifically, the signal processor 30 down-shifts, modulates and converts the broadband sub-octave signal f back into the digital signal 18. Next, the digital signal 18 is transferred from the signal processor 30 to the terminal 16.

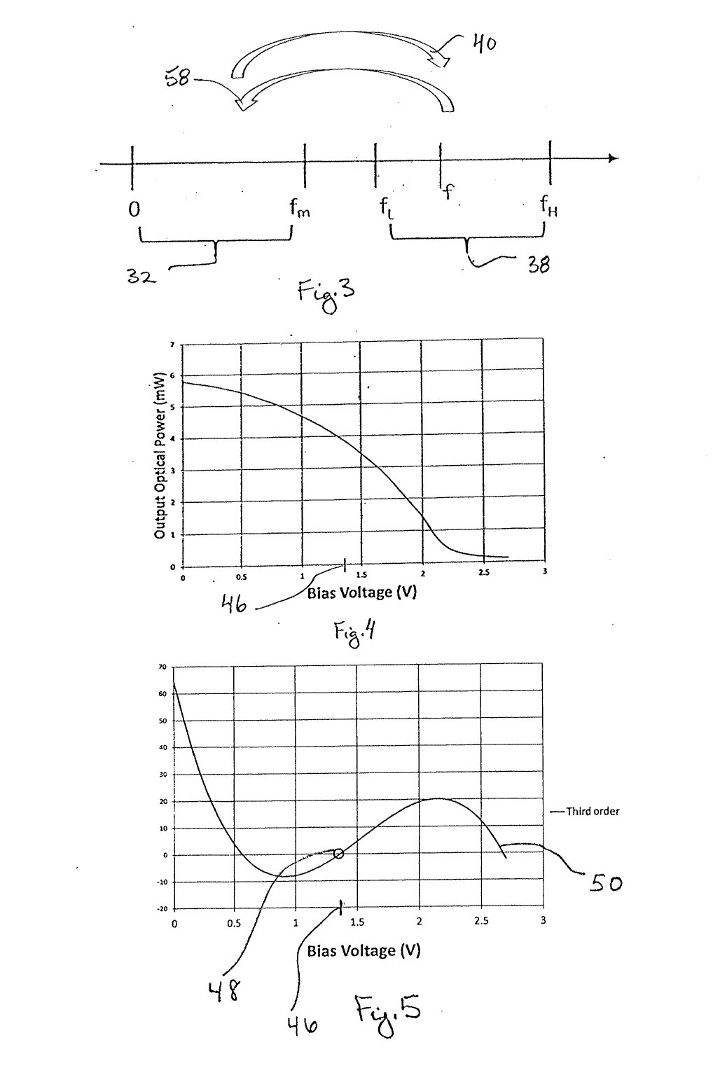

FIG. 2 shows, in greater detail, that the upstream signal processor 20 includes a digital/analog (D/A) converter 34. Specifically, it is envisioned for the system 10 that the D/A converter 34 will convert the digital signal 18 into an analog signal having a frequency that is within a multi-octave broadband between zero and fₘ (see FIG. 3).

An important aspect of the present invention is that the multi-octave analog signal created from the digital signal 18 be up-shifted to a frequency f that is within a sub-octave broadband. As noted above, and previously disclosed, the purpose for this up-shift is to minimize the second order distortions that may occur in the optical signal λ as it traverses the fiber optic 12. To do this, the signal processor 30 includes a frequency translator 36 that will up-shift the multi-octave analog signal to an carrier frequency f that is in a sub-octave broadband 38. Specifically, as shown in FIG. 3, the sub-octave broadband signal f will be between the frequencies f_{L} and f_{H} (f_{L}<f<f_{H}). Further, the bandwidth requirements for f are: f_{L}<f<f_{H}; f_{H}<2f_{L}; and f_{H}≅2f_{L}. This up-shifting is represented in FIG. 3 by the arrow 40.

It is another important aspect of the present invention that the output of EAM 22 (i.e. optical signal λ) be adjusted to have a predetermined optical power output. Specifically, the optical power output of a light source 42, which is connected with the EAM 22, is adjusted by a so-called DC offset at the EAM 22 to establish the predetermined optical power. In particular, this is done in order to suppress third order distortions that may occur in the optical signal λ as it passes through the fiber optic 12. A bias control 44 is provided for the purpose of adjusting the output of light source 42. Preferably, for purposes of the present invention, the light source 42 can be a laser diode (LD).

Cross-referencing FIG. 4 and FIG. 5, it will be appreciated that by selecting a bias voltage (i.e. DC offset) with the bias control 44 (e.g. bias voltage 46 in FIG. 4), a specific operating point 48 will be identified on the third order distortion curve 50 (see FIG. 5). For the present invention it is important that the third order distortion be effectively minimized or, preferably, eliminated. Thus, in the operational example shown in FIG. 5, the predetermined bias voltage has been selected by the bias control 44 to eliminate third order distortions in the optical signal λ as it passes along the fiber optic 12. At the same time, as shown in FIG. 4, it is noteworthy that variations in optical power are still available “as needed.”

At the downstream end 26 of the fiber optic 12, the optical signal λ is received at the receiver 54 (FIG. 2) which includes the optical/electrical (O/E) converter 28. With an O/E conversion, the broadband sub-octave signal f is recovered. The broadband sub-octave signal f is then transferred to the downstream signal processor 30. A frequency translator 56 in the signal processor 30 down-shifts the sub-octave signal f into the multi-octave broadband 32 as indicated by the arrow 58 in FIG. 3. An analog/digital converter 60 then de-modulates the multi-octave analog signal back into the digital signal 18. This reconstituted digital signal 18 is then transferred to the appropriate address at the terminal 16.

In another embodiment of the present invention, the respective up-shift and down-shift functions, to and from the sub-octave bandwidth between f_{L} and f_{H}, can be accomplished using high speed converters for D/A converter 34 and A/D converter 60, respectively. To do this, the capabilities of the D/A and A/D converters (34 and 60) must each include an increased sampling rate that is high enough to generate all of the frequency components within the sub-octave bandwidth. The benefit of this capability is that the digital signal is converted directly to and from an analog signal without the need for a hardware modulator or demodulator.

For this embodiment of the present invention, there is no need for either an up-shift frequency translator 36 or a down-shift frequency translator 56. Instead, the D/A converter 34 and the A/D converter 60 are each programmed with appropriate software to perform the frequency shifting functions. Further, for this alternate embodiment, the software programming can be accomplished to synthesize a frequency f that is in the sub-octave bandwidth where: f_{L}<f<f_{H}; f_{H}<2f_{L}; and f_{H}≅2f_{L}.

While the particular System and Method for Broadband Transmissions on a Fiber Optic with Suppression of Second and Third Order Distortions as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for transmitting telecommunication signals from an upstream end of a fiber optic to a downstream end of the fiber optic, with suppression of second order and third order distortions, the system comprising:
a signal processor for generating a sub-octave broadband signal having an carrier frequency, f; and
an Electro-Absorption Modulator (EAM) for receiving the sub-octave broadband signal, and for modulating the sub-octave broadband signal into an optical signal λ, wherein a DC offset voltage is provided for altering an optical output power of the optical signal λ, and wherein the sub-octave broadband transmission minimizes second order distortions of the optical signal λ, and the DC offset minimizes third order distortions when the optical signal λ is transmitted on the fiber optic.

2. A system as recited in claim 1 wherein the telecommunication signals are a digital data stream, and the signal processor further comprises a digital/analog (D/A) converter for converting the digital data stream into an analog signal.

3. A system as recited in claim 2 wherein the signal processor further comprises:
a modulator for modulating the analog signal; and
an up-shift frequency translator for up-shifting the modulated analog signal to the carrier frequency f in the sub-octave broadband.

4. A system as recited in claim 3 wherein the carrier frequency f of the sub-octave broadband signal is between a frequency f_{L} and a frequency f_{H}, (i.e. f_{L}<f<f_{H}) and wherein f_{H}<2f_{L} and f_{H}2f_{L};

5. A system as recited in claim 3 wherein the analog signal has an carrier frequency less than fₘ in a multi-octave broadband prior to up-shifting, and wherein fₘ is less than f, (fₘ<f).

6. A system as recited in claim 1 further comprising a light source for generating a light beam having a wavelength λ, and wherein the light source is connected to the EAM.

7. A system as recited in claim 6 further comprising a voltage source connected with the EAM, wherein the EAM receives the light beam λ from the light source and a bias voltage from the voltage source is provided to the EAM for altering an optical power of the light beam λ with the DC offset.

8. A system as recited in claim 1 further comprising a receiver connected to the downstream end of the fiber optic, wherein the receiver incorporates an optical-electrical (OE) converter to convert the optical signal λ into the RF sub-octave broadband signal.

9. A system as recited in claim 8 further comprising a down-shift frequency translator for down-shifting the RF sub-octave broadband signal into a multi-octave broadband signal.

10. A system as recited in claim 9 further comprising an analog/digital (A/D) converter for converting the multi-octave broadband signal into a digital data stream.

11. A system for transmitting telecommunication signals from an upstream end of a fiber optic to the downstream end of the fiber optic, with suppression of second order and third order distortions, the system comprising:
a light source for generating a light beam having a wavelength λ;
a frequency modulator for modulating a telecommunication signal;
an up-shift frequency translator for up-shifting the modulated signal into a sub-octave broadband signal, wherein a sub-octave bandwidth for the up-shifted signal extends between a frequency f_{L} and a frequency f_{H}, and wherein f_{H}<2f_{L} and f_{H}≅2f_{L};
an Electro-Absorption Modulator (EAM) for receiving the light beam as a first input, and for receiving the sub-octave broadband signal as a second input to modulate the sub-octave broadband signal into an optical signal λ; and
a voltage source connected with the EAM to provide a bias voltage for altering an optical power of the optical signal λ with a DC offset, wherein the DC offset minimizes third order distortions of telecommunication signals transmitted on the fiber optic, and the sub-octave broadband transmission minimizes second order distortions of the telecommunication signals when transmitted as an optical signal on the fiber optic.

12. A system as recited in claim 11 wherein the telecommunication signals are a digital data stream and the system further comprises a digital/analog (D/A) converter for converting the digital data stream into an analog signal.

13. A system as recited in claim 12 wherein the analog signal has an carrier frequency in a multi-octave broadband prior to up-shifting.

14. A system as recited in claim 11 wherein the light source is a laser diode.

15. A system as recited in claim 11 further comprising a receiver connected to the downstream end of the fiber optic, wherein the receiver incorporates an optical-electrical (OE) converter to convert the optical signal λ into an RF sub-octave broadband signal.

16. A system as recited in claim 15 further comprising a down-shift frequency translator for down-shifting the RF sub-octave broadband signal into a multi-octave broadband signal.

17. A system as recited in claim 16 further comprising an analog/digital (A/D) converter for converting the multi-octave broadband signal into a digital data stream.

18. A method for transmitting telecommunication signals from an upstream end of a fiber optic to the downstream end of the fiber optic, with suppression of second order and third order distortions, the method comprising the steps of:
creating a digital data stream;
converting the digital data stream into a multi-octave analog signal;
modulating the analog signal;
up-shifting the modulated analog signal into a sub-octave broadband signal having an carrier frequency f, wherein a bandwidth for the up-shifted sub-octave broadband signal extends between a frequency f_{L} and a frequency f_{H}, and wherein f_{L}<f<f_{H}; f_{H}<2f_{L}; and f_{H}≅2f_{L};
generating a light beam having a wavelength λ;
modulating the light beam λ with the sub-octave broadband signal to create an optical signal λ;
altering an optical power of the optical signal λ with a DC offset; and
transmitting the optical signal λ over the optical fiber, wherein the DC offset minimizes third order distortions of telecommunication signals transmitted on the fiber optic, and the sub-octave broadband transmission minimizes second order distortions of the telecommunication signals when transmitted as an optical signal on the fiber optic.

19. A method as recited in claim 18 further comprising the steps of:
receiving the optical signal at the downstream end of the fiber optic;
converting the optical signal λ into an RF sub-octave broadband signal;
down-shifting the RF sub-octave broadband signal into a multi-octave broadband signal; and
converting the multi-octave broadband signal into the digital data stream.

20. A method as recited in claim 19 further comprising the step of transferring the digital data stream to a destination terminal.
